(19) United States
(12) Patent Application Publication
(10) Pub. No.: US 2005/0210247 A1
(43) Pub. Date: Sep. 22, 2005

(54) Method of virtual challenge response authentication

(76) Inventors: Peng T. Ong, Singapore (SG); Eng-Kiat Koh, Foster City, CA (US)

Correspondence Address: THOMAS S. KEATY;KEATY PROFESSIONAL LAW CORP., 2140 WORLD TRADE CENTER, NO. 2 CANAL STREET, NEW ORLEANS, LA, 70130, US

(21) Appl. No.: 10/803,752

(22) Filed: Mar. 18, 2004

(51) Int. Cl. H04L 9/00

(52) U.S. Cl. 713/168

(57) ABSTRACT

A method of authentication that provides the security of a challenge response authentication is described. The method is compatible with an existing infrastructure password-based authentication.

### FIELD OF THE INVENTION

The present invention relates to a security device for computer systems, and, more particularly, to an authentication mechanism based on the principles of challenge response, to be deployable in a manner that is compatible with existing password-based authentication infrastructure.

### BACKGROUND OF THE INVENTION

With rapid growth of Internet and networks, the popularity of electronic communication rises among users of network services. In order to provide secure access to network services, users are authenticated before being allowed to log into a system providing particular network services. The most common method of authentication is using user name and password. We call this password-based authentication (PBA).

A typical protocol that PBA systems used to connect the server that provides authentication service is RADIUS. RADIUS belongs to a class of authentication protocols called “indirect authentication protocol” where the authentication servers do not contain user information, instead depending on user information stored in a centralized server. TCACS+ and XTACAS are other examples of such protocols. In certain mode of operation such as using Password Authentication Protocol (PAP), the protocol expects a user id and a password as input.

Because password-based authentication (PBA) requires transmission of long-lasting secrets (i.e. passwords), it is vulnerable to various forms of attacks. For example, users may accesses several applications, each with its own separate authentication mechanism causing the user to remember multiple user names and passwords. Due to this inconvenience users usually utilize the same user name and password for multiple applications that they access. In addition, users choose easy to remember passwords, which are usually subject to attack by hackers. Cracking of one password for one account breaches other accounts with the same user name and password. Network setups such as wireless Local Area Networks, remote access features, weak intrusion protection increase vulnerability of passwords to technical attacks by hackers.

To overcome the vulnerability of PBA, a more secure authentication process has been developed for accessing a server (or application) from a client: the server issues a challenge and the client issues a response based on the challenge. We call this a “traditional challenge/response” authentication (TCRA) process.

If a strong cryptographic method (such as public key encryption or some method of symmetric key encryption) is used in generating the response, then, because of the strength of the authentication protocol, most identity theft attacks on the system will be through means other than the authentication process.

The problem with TCRA is that most existing authentication systems are password-based. There is no provision for a server-to-client challenge in the authentication protocol. There is just an expectation of a “response,” which is the password.

What is needed, therefore, is a solution which overcomes these and other shortcomings of the prior art.

### SUMMARY OF THE INVENTION

It is, therefore, an object of the present invention to provide a system of user authentication that can be used in the electronic communication environment.

It is another object of the present invention to provide a user authentication system that relies on virtual challenge and response sequence generated by server and user.

It is a further object of the present invention to provide a software product executing the method of authentication of the instant invention operational when executed by a processor.

These and other objects of the invention are achieved through a provision of a method and software for authenticating a user without first communicating with a service network. The method provides for generation of a challenge that is encrypted and can be decrypted by user's private or public key. The user generates a response to the challenge, and the generated challenge is transmitted to a network access server, which forwards the response to an authentication server. The response is decrypted and, if matches the encrypted challenge—the user is allowed access to the service network.

The Virtual Challenge/Response Authentication (VCRA) method and software of the present invention is a means to achieve the strength of TCRA using existing PBA infrastructure. It is recognized that the “challenge” cannot be transmitted using a PBA system's protocol; therefore, in a VCRA system, the challenge will come from elsewhere. The possible sources of the “challenge” in a VCRA system include:
the current time
the time as provided by a trusted clock (trusted by both client and server)
a non-repeating sequence that is synchronized between client and server (e.g. 1, 2, 3 . . . )
a random number that is generated by a “challenge generator” which is trusted by both client and server.

Assuming a public-key-based VCRA, the “response” by the user will be a signed version of the challenge. A VCRA system would therefore just have to provide an authentication service to the server to check the validity of the response (to the challenge, which was possibly generated by the challenge generator). The authentication service in this invention can be in the form of a RADIUS interface—minimizing changes needed on the server side to migrate to a VCRA system.

The drawback with a signature-based response is that the length of a private-key-signed-hash (i.e. the response) is longer than the maximum length of passwords in the PBA. The alternative is to have a random number encrypted by the public key of the client. The response, in this case, will be the decrypted random number.

### BRIEF DESCRIPTION OF THE DRAWINGS

The present invention is illustrated by way of example and not limitation in the figures of the accompanying drawings, in which like references indicate similar elements and in which:

FIG. 1 is a schematic view illustrating an exemplary system architecture according to first preferred embodiment of the present invention.

FIG. 2 is a schematic view illustrating an exemplary system architecture according to second preferred embodiment of the present invention.

### DETAILED DESCRIPTION OF THE PREFERRED EMBODIMENTS

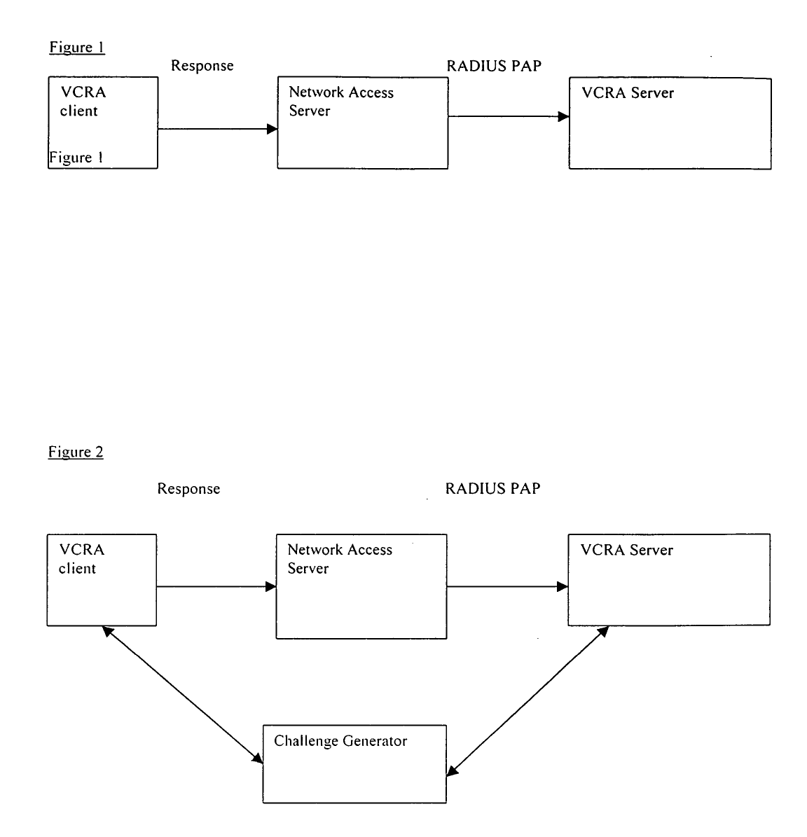

Turning now to the first embodiment of FIG. 1, the authentication mechanism relies on a challenge that can be derived by the client without communicating to the server. To derive the challenge, time or a non-repeating sequence of number based on an initial seed can be used. A client is initialized with id and a seed number that the server knows about. When using a non-repeating sequence for creating a challenge, the following steps are followed:

1. Generate a random positive sequence number, N.

2. Apply a one-way hash function on the seed number for N number of times.

3. Obtain challenge by appending the user id, the sequence number N and the result of the Nth way hashing.

Alternatively, the positive sequence number N is derived from time instead of being randomly generated.

The next step in the authentication of the user is generation of a response. One of the ways to generate the response is by encrypting the derived challenge using user's private key through the use of a public-key cryptographic algorithm such as RSA. The user's private key is stored in a smart card device.

The next step in the user of authentication process is sending the response. This function may be performed by injecting the response in the standard password field in the User Interface found on most client applications. The response will reach the authentication server, which in turn will send the response as a password field using RADIUS to the authentication server that performs VCRA.

Once the server receives the response, it must be verified. In one embodiment, the RADIUS server uses the algorithm to verify the response on the server according to the following protocol:

1. Look up the user's public key and decrypt the response to obtain the challenge. The challenge should contain the sequence number N, hash result and user id.

2. Look LIP the user's seed number using user id.

3. Apply the one-way hashing function Nth time and compare the result with what is obtained from the client.

4. The user is authenticated if the result is the same.

This authentication protocol is another variant of “indirect authentication protocol.”

In the second preferred embodiment, the authentication mechanism relies on a challenge that can be obtained by communicating with a Challenge Generator trusted by both the authentication server and the client. The following describes the difference between this embodiment and the first preferred embodiment. Turning to the schematic diagram of FIG. 2, the first step in the authentication process is for the client to contact a trusted Challenge Generator and obtain a random encrypted number using the public key of the user using a public key algorithm such as RSA.

The client then generates the response by decrypting the random number using the private key of the user. The generated response can be sent by injecting the random number in the standard password field in the User Interface found on most client applications. The response will reach the authentication server, which in turn sends the response as a password field using RADIUS to the authentication server that performs VCRA.

To verify the response, the authentication server contacts the Challenge Generator to obtain the same encrypted random number that the client has received. The server encrypts the response using the user's public key. If the two encrypted numbers are the same, the user is authenticated.

Both embodiments of the invention rely on RADIUS-type password authentication protocol (PAP). Other types of authentication protocol, such as TACAS, TACAS+ or XTACAS may be used. It is envisioned that the authentication method of the present invention may also be used with other protocols as long as the challenge/response sequence of the instant method is followed. In both variants of the authentication method the authentication challenge is obtained outside of the authentication protocol.

The authentication method of the present invention can be stored on storage medium operational to store the authentication software. The software product executing the method of authentication of the instant invention provides for authentication software operational when executed by a processor to direct the processor to generate a challenge without communicating with the network server, encrypt the challenge, receive the user response to the challenge, process the user response to determine if the user is allowed access to the service network based on decrypting the user response and matching the user response with the encrypted challenge, and provide access to the service network to the user in response to the authorization response that allows the user to use the service network.

Many changes and modifications may be made in the method of the present invention without departing from the spirit thereof. I, therefore, pray that my rights to the present invention be limited only by the scope of the appended claims.

1. A method of operating an access system including a network access server to provide access between a user and a service network, the method comprising the steps of:
providing an authentication server;
generating a challenge using a random sequence without communicating with the network access server;
generating a response to the challenge;
sending the response to the network access server using an authentication protocol;
forwarding the response to the authentication server;
receiving and processing the response indicating whether the user is allowed access to the service network by decrypting the response using a user encrypted private key;
providing access to the service network to the user in response to the authorization generated by the authentication server.

2. The method of claim 1, wherein the challenge is generated based on time.

3. The method of claim 1, wherein the challenge is generated based on a non-repeating number sequence.

4. The method of claim 1, wherein the authentication protocol is an indirect authentication protocol.

5. The method of claim 1 wherein the authentication protocol is RADIUS.

6. The method of claim 1 wherein the authentication protocol is TACAS.

7. The method of claim 1 wherein the authentication protocol is TACAS+.

8. The method of claim 1 wherein the authentication protocol is XTACAS.

9. The method of claim 1, wherein the response is generated using public-key cryptographic algorithm and encrypting the challenge with the user's private key.

10. The method of claim 1, wherein the response is generated using symmetric key cryptographic algorithm and encrypting the challenge with a shared secret.

11. The method of claim 9, wherein the user's private key is stored in a smart card device.

12. A method of operating an access system including a network access server with an established authentication protocol to provide access between a user and a service network, the method comprising the steps of:
providing an authentication server;
providing a challenge generator;
generating a challenge through a communication channel outside the authentication protocol using a random number sequence using encryption by a user public key;
generating a response to the challenge by decrypting the random number using a user private key;
sending the generated response to the network access server through the authentication protocol and to the challenge generator;
forwarding the response to the authentication server;
receiving and processing the response indicating whether the user is allowed access to the service network by decrypting the response using the user encrypted public key;
providing access to the service network to the user in response to the authorization generated by the authentication server.

13. The method of claim 12, wherein the authentication protocol is an indirect authentication protocol.

14. The method of claim 12, wherein the authentication protocol is RADIUS.

15. The method of claim 12, wherein the authentication protocol is TACAS.

16. The method of claim 12, wherein the authentication protocol is TACAS+.

17. The method of claim 12, wherein the authentication protocol is XTACAS.

18. The method of claim 12, wherein the challenge generator is configured to generate and transmit a challenge query.

19. A software product for providing access between a user and a service network access equipped with a network access server, the software product comprising:
authentication software operational when executed by a processor to direct the processor to generate a challenge without communicating with the network server, encrypt the challenge, receive the user response to the challenge, process the user response to determine if the user is allowed access to the service network based on decrypting the user response and matching the user response with the encrypted challenge, and provide access to the service network to the user in response to the authorization response that allows the user to use the service network; and
a software storage medium operational to store the authentication software.

20. The software product of claim 19, wherein the user response includes a random number decrypted using a user private key.

21. The software product of claim 20, wherein the user response includes a non-repeating number sequence decrypted using a user encrypted private key.
